(19) United States
(12) Patent Application Publication
(10) Pub. No.: US 2010/0103448 A1
(43) Pub. Date: Apr. 29, 2010

(54) METHOD AND APPARATUS FOR VOUCHER AND PROMOTIONAL COUPONING SYSTEM

(75) Inventor: Eric Meyerhofer, Glendale, CA (US)

Correspondence Address: FITZPATRICK CELLA HARPER & SCINTO, 1290 Avenue of the Americas, NEW YORK, NY, 10104-3800, US

(73) Assignee: FUTURELOGIC, INC., Glendale, CA (US)

(21) Appl. No.: 12/530,459

(22) PCT Filed: Mar. 10, 2008
(86) PCT No.: PCT/US08/56404

§ 371 Date: Dec. 15, 2009

Related U.S. Application Data
(60) Provisional application No. 60/894,168, filed on Mar. 9, 2007.

(51) Int. Cl. G06F 3/12

(52) U.S. Cl. 358/1.15

(57) ABSTRACT

A method and apparatus are provided for the creation and management of promotional coupons or vouchers. When used in a mixed gaming and promotional couponing system, a printer appends printed indicia to printed output when receiving data on an auxiliary port configured for printing promotional coupons. In addition, the printer, upon receiving data on the auxiliary port, may analyze the received data in order to suppress data for generating certain patterns which are not desirable to appear on the printed output. Suppressed data may include text, barcode, graphic, line, and box data used for printing vouchers but not promotional coupons.

### CROSS-REFERENCE TO RELATED APPLICATION

The present application claims the benefit U.S. Provisional Application No. 60/894,168 filed Mar. 9, 2007, the contents of which are incorporated by reference as if stated in full herein.

### BACKGROUND OF THE INVENTION

This invention relates generally to promotional couponing systems and more particularly the creation of coupons and vouchers using the same printer in a gaming, vending or other business environment.

Gaming machine manufacturers have introduced cashless enabled gaming machines to the market and these have begun to find wide acceptance in the gaming industry. Cashless enabled gaming machines are so named because they can conduct financial exchanges using a mixture of traditional currencies and vouchers. Typically, a cashless enabled gaming machine has a gaming printer to produce vouchers and a bill acceptor that supports automatic reading of vouchers. To coordinate the activities of multiple cashless enabled gaming machines, one or more cashless enabled gaming machines may be electronically coupled to a cashless enabled gaming machine system that controls the cashless operations of a cashless enabled gaming machine.

Cashless enabled gaming machines have found increasing acceptance and use in the gaming industry with players who enjoy the speed of play and ease of transporting their winnings around a gaming establishment and the gaming establishments who have realized significant labor savings in the form of reduced coin hopper reloads in the games, and an increase in revenue because of the speed of play. Gaming and vending machine manufacturers have increasingly added additional printing features to their gaming and vending machines. One of these features is the ability to create promotional coupons from the vending machines. However, there is no method or system in place to create, issue, and manage promotional coupons, promotions, or promotional campaigns which may be transmitted to, stored in, and used by a printer.

Promotional coupon generation and issuance can include a system which edits the layout of a promotional coupon template. While this method may allow a user to design promotional coupons, it does not allow the association of promotional coupons to one or more promotions or the association of one or more promotions to a promotional campaign. Another problem with this method is the inability to copy promotional coupon print regions from one promotional coupon template to another template.

Promotional coupon generation and issuance can also include the direct mailing of promotional coupons from a gaming or other business establishment to consumers. One problem that plagues this method is that the promotion must be planned well in advance to accommodate the printing and mailing of the promotional coupons to consumers. Another problem is direct mailing and printing is not cost effective. Another problem is that the preprinted promotional coupons cannot be directly inserted into or read by a bill acceptor in a gaming or vending machine. The preprinted promotional coupons must be processed by hand, the process which lends itself to fraud and security issues such as forgery.

Promotional coupon generation and issuance can also include providing consumers the means to download promotions from a networked environment (typically the Internet) for a gaming or other business establishment. In addition to some of the problems cited for the previously described existing methods, problems for this existing method also include the lack of the consumer's presence at a gaming or other business establishment which reduces the promotion's overall effectiveness and promotional coupon redemption.

In some promotional couponing systems, both vouchers and promotional coupons are printed by the same printer using data received from two or more communication ports. Data for generating vouchers are received at a main communication port of the printer and data for generating promotional coupons are received at one or more auxiliary communication ports. While the main communication port may be secure in that it is only accessible to a gaming machine or other voucher data source, the auxiliary communication ports may be accessible to non-secure devices. Therefore, a need exists to prevent use of the auxiliary communication port to generate promotional items that may be confused with vouchers.

### SUMMARY OF THE INVENTION

In one aspect of a system in accordance with an exemplary embodiment of the present invention, a printer appends printed indicia to printed output upon receiving data on an auxiliary port, thereby identifying that the printed output was driven by data on the auxiliary port. An auxiliary port includes a communication port configured for printing promotional coupons, among other types of objects. Indicia may include human-readable or machine-readable background patterns, watermarks, and embossments, etc.

In another aspect of a system in accordance with an exemplary embodiment of the present invention, a printer, upon receiving data on an auxiliary port, analyzes the received data in order to suppress data for generating certain patterns which are not desirable to appear on the printed output driven by data on the auxiliary port. Suppressed data include text, barcodes, graphics, lines, box or position data that may be used for printing a voucher but not a promotional coupon.

For example, a gaming establishment desires to ensure that a gaming machine does not accidentally print promotional coupons using voucher data. The gaming establishment configures the printer of the gaming machine to suppress barcode data so that a gaming machine will not print promotional coupons with voucher barcodes. Additionally, the gaming establishment configures the printer to print a watermark visually identifying printed output as a promotional coupon, thereby reducing the likelihood that a cashier will mistake the promotional coupon for a voucher.

These and other advantages can be realized by various systems in accordance with exemplary embodiments of the present invention.

### BRIEF DESCRIPTION OF THE DRAWINGS

These and other features, aspects, and advantages of the present invention will become better understood with regard to the following description, accompanying drawings and appendix where:

FIG. 1 is a process flow diagram of the promotional couponing system in accordance with an exemplary embodiment of the present invention.

FIG. 2 is an illustration of the attributes of the print regions of a voucher or promotional coupon template in accordance with an exemplary embodiment of the present invention.

FIG. 3 is an illustration of a promotional coupon including logical fields in accordance with an exemplary embodiment of the present invention.

FIG. 4 is an illustration of the attributes of the communication settings with a printer in accordance with an exemplary embodiment of the present invention.

FIG. 5 is an illustration of the attributes of the printer settings in accordance with an exemplary embodiment of the present invention.

FIG. 6 is a process flow diagram for vouchers and promotional data in a gaming environment in accordance with an exemplary embodiment of the present invention.

FIG. 7 is a process flow diagram for printing vouchers and promotional data in a gaming environment in accordance with an exemplary embodiment of the present invention.

FIG. 8 is a process flow diagram for printed vouchers and promotional data in a gaming environment in accordance with an exemplary embodiment of the present invention.

FIG. 9a is an illustration of printed output showing printed indicia in accordance with an exemplary embodiment of the present invention.

FIG. 9b is an illustration of printed output showing suppressed data in accordance with an exemplary embodiment of the present invention.

FIG. 10 is a block diagram of a printer in accordance with an exemplary embodiment of the present invention.

FIG. 11 is a block diagram of a host for creation of a promotion in accordance with an exemplary embodiment of the present invention.

APPENDIX A is a list of definitions of terms as used herein.

Identically labeled elements appearing in different ones of the figures refer to the same elements but may not be referenced in the description for all figures.

### DETAILED DESCRIPTION

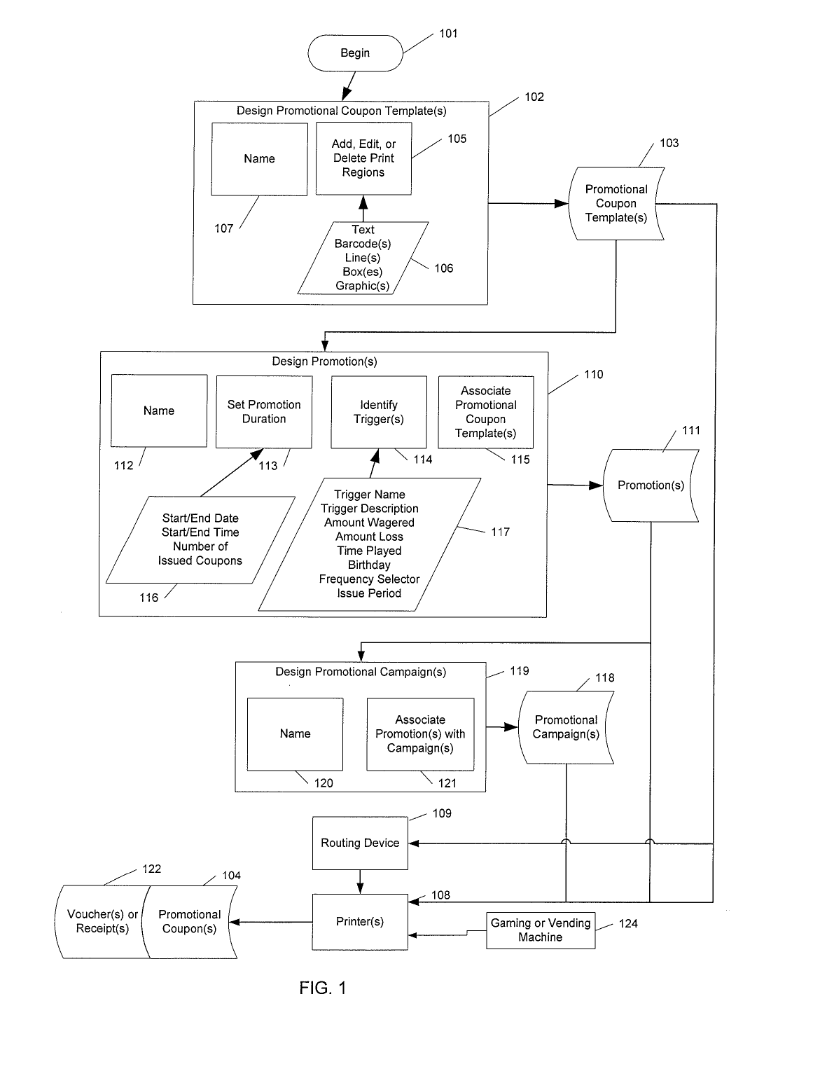

FIG. 1 is a process flow diagram of the promotional couponing system in accordance with an exemplary embodiment of the present invention. As illustrated the process begins (101) when a user uses a user input device (not shown) to design (102) a promotional coupon template 103 which is used to create promotional coupons 104. Print regions can be added, edited, or deleted (105) from promotional coupon template 103. The print regions which may be included on promotional coupon template 103 are text or plurality of text, a barcode or plurality of barcodes, a line or plurality of lines, a graphic or plurality of graphics, and a box or plurality of boxes, as shown in element 106. As promotional coupon template 103 is designed, the appearance of promotional coupons 104 is displayed to the user on a user output device (not shown) such as a screen or other display.

Each promotional coupon template is given (107) a name. The data for promotional coupon template 103 is stored on a host system and may be used in a promotion or a plurality of promotions. The data for each promotional coupon template 103 may also be transmitted to, stored in, and used by a printer 108 or plurality of printers to generate promotional coupon 104 or a plurality of promotional coupons.

The data for each promotional coupon template 103 may also be transmitted to and stored in a routing device 109 or a plurality of routing devices, each which is coupled to a printer, such as printer 108. Routing device 109 transmits the stored data to printer 108 to generate promotional coupon 104 or a plurality of promotional coupons.

If promotional coupon template 103 or plurality of promotional coupon templates is used in a promotion or plurality of promotions, the process continues with the design (110) of a promotion 111 or plurality of promotions. Each promotion 111 is given (112) a name, the promotion duration is set (113), triggers are identified (114), and promotional coupon templates are associated (115). The promotion duration parameters include start and end date, start and end time, and number of issued promotional coupons, among others, as shown in element 116. The triggers include amount wagered, amount loss, time played, birthday, frequency selector, and issue period among others, as shown in element 117. The promotional coupon trigger is given a name and described. The data for each promotion 111 is stored on a host system and may be used in any promotional campaign or plurality of promotional campaigns. The data for each promotion may also be transmitted to printer 108 or plurality of printers to generate promotional coupon 104 or a plurality of promotional coupons.

The data for each promotion may also be transmitted to and stored in routing device 109 or a plurality of routing devices, each which is coupled to a printer, such as printer 108. Routing device 109 transmits the stored data to printer 108 to generate promotional coupon 104 or a plurality of promotional coupons.

If promotion 111 or plurality of promotions is to be used in a promotional campaign 118 or plurality of promotional campaigns, the process continues with the design (119) of a promotional campaign or plurality of promotional campaigns. Each promotional campaign is given (120) a name and a promotion or plurality of promotions is associated (121) with each promotional campaign 118. The data for each promotional campaign 118 is stored on a host system and may be transmitted to printer 108 or a plurality of printers to generate promotional coupon 104 or a plurality of promotional coupons.

The data for each promotional campaign 118 may also be transmitted to and stored in routing device 109 or a plurality of routing devices, each which is coupled to a printer, such as printer 108. Routing device 109 transmits the stored data to printer 108 to generate promotional coupon 104 or a plurality of promotional coupons. In addition, as printer 108 is also coupled to a gaming or vending machine 124, printer 108 may print vouchers 122 along with promotional coupon 104.

In one system in accordance with an exemplary embodiment of the present invention, data for promotional coupon templates, promotions, and promotional campaigns are stored in routing device 109 coupled to printer 108. In this system, the promotional couponing system transmits the data for promotional coupon templates, promotions, and promotional campaigns to routing device 109. When all the parameters for a promotion or promotional campaign are met, the routing device transmits the stored data to printer 108 to generate promotional coupon(s) 104.

In another system in accordance with an exemplary embodiment of the present invention, a user can create promotional coupons 104, promotions, and promotional campaigns in real time, thereby allowing up-to-the-minute or last-minute implementations. Using such a system, the gaming establishment creates the promotional coupon template and the promotion. The data for the promotional coupon and promotion is saved on the host system and sent to printer 108 in one or more cashless enabled gaming machines. If the criteria set for the promotion is met, the printer then issues the promotional coupon to a consumer.

In one system in accordance with an exemplary embodiment of the present invention, promotional coupon templates 101 written in a template definition language, promotions 111, and promotional campaigns 118 are designed using a host system and a graphical front-end to a template definition language.

When a gaming or other business establishment desires to define a promotional coupon, the promotional coupon template where the layout and print regions of text, graphics, barcodes, lines, and boxes are defined as displays. A gaming or other business establishment defines the layout of promotional coupon templates 103 by placing print regions on the promotional coupon template. For example, the user desires to place a barcode as a print region on promotional coupon templates 103. The user selects the barcode option to define the parameters for that barcode. The parameters include, for example, region ID, region data, region size, object ID, object rotation, object width, object justification, object attributes, print attributes, and print color among others. These parameters are also used to modify a print region.

The user can move any region to another area on promotional coupon templates 103, place a region in front of other regions, or place a region behind other regions.

Another system in accordance with an exemplary embodiment of the present invention allows multiple promotional coupon templates 103 to be created based on existing promotional coupon templates. In this system, a gaming or other business establishment selects an existing promotional coupon template on which additional promotional coupon templates 103 are based. Each additional promotional coupon template inherits the characteristics of the selected existing promotional coupon template but can be separately modified. Using the promotional coupon template editor which displays, a gaming or other business establishment can create a new promotional coupon template, delete a selected promotional coupon template, and display or hide print regions on a promotional coupon template.

Another system in accordance with an exemplary embodiment of the present invention allows the user to adjust the workspace for structuring the promotional coupon templates 103. Thus, if desired, the user can zoom in on the overall layout and print regions of promotional coupon templates 103 to closely view and modify the overall layout and print regions. This feature also permits users to zoom out to view the overall layout and print regions of promotional coupon templates 103.

In another system in accordance with an exemplary embodiment of the present invention, after the gaming or other business establishment defines the print regions for the promotional coupon template, a promotional coupon template is stored in a document. The document contains multiple lines. Each line contains a command and the associated parameters required to use that promotional coupon template. The document is stored on a host system and may be incorporated into a new or existing promotion 111. The data may also be transmitted to, stored in, and used by printer 108 either alone or with other promotional coupon templates 103 to generate promotional coupons 104. The data may also be transmitted to and stored in a routing device 109 coupled to printer 108, with routing device 109 transmitting the stored data to printer 108 to generate promotional coupons 104.

One system in accordance with an exemplary embodiment of the present invention allows the overall layout and print regions of promotional coupon templates 103 to be edited or deleted. The parameters for a print region which can be edited include region ID, region data, region size, object ID, object rotation, object width, object justification, object attributes, print attributes, and print color among others.

In addition, one system in accordance with an exemplary embodiment of the present invention allows the export of promotional coupon templates 103 and data for promotional coupons 104, promotions 111, and promotional campaigns 118 for incorporation and use by external software applications such as a casino management system or player tracking system.

Furthermore, another system in accordance with an exemplary embodiment of the present invention provides various methods of establishing communications with printer 108 for data transmission. In one aspect of such a system, when a gaming or other business establishment desires to set up the communication port to which data is transmitted to printer 108, the communication port settings are displayed. A gaming or other business establishment selects the communication port and the communication protocol baud rate, identifies the polling option and command, and initializes the communication port. In addition, a gaming or other business establishment can locate additional communication ports to which to establish communications with printer 108 or routing device 109.

In another aspect of a system in accordance with an exemplary embodiment of the present invention, when a gaming or other business establishment desires to set up the respective communication ports to which vouchers and promotional coupon data is transmitted to printer 108, the communication ports settings are displayed. A gaming or other business establishment selects a voucher file, selects the communication port and the communication protocol baud rate, and initializes the communication port for the voucher. A gaming or other business establishment repeats this process for a promotional coupon.

A gaming or other business establishment can also set the delay between print option which sets the delay print time between printing a voucher 122 and printing promotional coupons 104. A gaming or other business establishment can also disconnect the communication port for the voucher, the promotional coupon, or both.

When a gaming or other business establishment desires to view the parameters of a print job prior to sending a data to a printer, print job controls are displayed. A gaming or other business establishment can select options such as manually sending the print job, sending all print jobs without delay, sending all print jobs with delay, canceling a print job, and clearing the output log that is created when a print job is sent to printer 108.

A gaming or other business establishment can also view the status of printer 108. When desiring to do so, the printer status displays. A gaming or other business establishment can view any communication errors, such as Universal Asynchronous Receiver Transmitter (UART) errors, view the printer library, and reset printer 108 if necessary.

In another system in accordance with an exemplary embodiment of the present invention, data for promotional campaigns 118 which may be transmitted to printer 108 from a host system, stored in, and used by printer 108 to generate a promotional coupon or a plurality of promotional coupons, may be combined with data for promotional coupons 104. In this system, when a gaming or other business establishment desires to create or edit promotional campaigns 118, promotions 111 and promotional campaigns 118 are defined as displays. After a gaming or other business establishment creates or edits promotional campaigns 118, the system inserts a header in a promotional campaign data file 118 which identifies a promotional campaign. The system also calculates a signature, such as a CRC, based on the contents of the promotional campaign data and sends the signature to printer 108.

In another aspect of a system in accordance with an exemplary embodiment of the present invention, a boundary check on the combined promotional coupon templates 103, print regions, graphics and other data which may be included with the promotional campaign 118 data may be performed to ensure conformance with the resources and load requirements of printer 108. In this system, after a gaming or other business establishment transmits data to printer 108, the promotional couponing system performs the boundary check by determining the number of promotional coupon templates 103, print regions, graphics and other data which may be included with promotional campaign 118 data. The promotional couponing system then verifies the signature. After successful verification of the signature, the promotional couponing system loads the data for each promotional coupon template and sends the signature to printer 108.

In another aspect of a system in accordance with an exemplary embodiment of the present invention, data for promotional coupon templates, promotions, and promotional campaigns are stored in the memory of printer 108. In this system, the promotional couponing system transmits the data for promotional coupon templates, promotions, and promotional campaigns to printer 108. When all parameters of promotions 111 or promotional campaigns 118 are met, the printer uses the data stored in memory to generate promotional coupons 104.

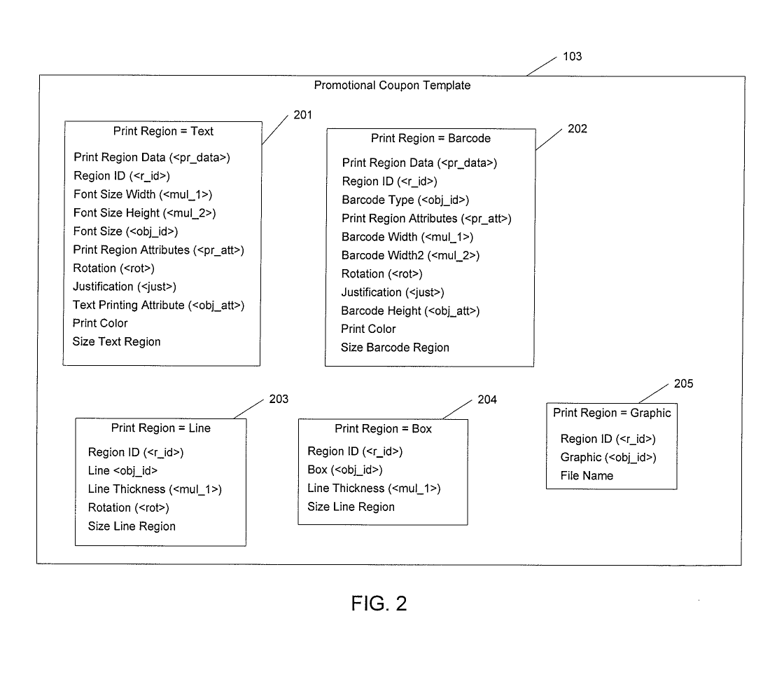

FIG. 2 is an illustration of the attributes of the print regions of a promotional coupon template 103 in accordance with an exemplary embodiment of the present invention.

As illustrated, a promotional coupon template may include text print regions 201, barcode print regions 202, line print regions 203, box print regions 204, and graphic print regions 205.

The attributes for text print region 201 are defined in Table I as follows:

TABLE I

| Attribute | Description |
|---|---|
| Print Region Data (<pr_data>) | Permanently stored data. Can modify |
| | if <pr_att> = dynamic, incrementing, |
| | or decrementing |
| Region ID (<r_id>) | Print Region identifier. Unique |
| | alphanumeric character |
| Font Size Width (<mul_1>) | The width of the size of the font. |
| Font Size Height (<mul_2>) | The height of the size of the font. |
| Font Size (<obj_id>) | An object identifier which describes |
| | the size of the font. |
| Print Region Attributes (<pr_att>) | Special handling instructions for |
| | the print region. Options for |
| | text include: Dynamic, Stored, |
| | Incrementing, or Decrementing. |
| Rotation (<rot>) | Rotation of strings or data with the |
| | print region. Options include: |
| | 0, 90, 180, or 270 Degrees. |
| Justification (<just>) | Justification of data within the |
| | print region. Options include: |
| | Left, Right, or Center. |
| Text Printing Attribute (<obj_att>) | Special handling instructions for |
| | the print object. |
| | Options for text include: Normal |
| | or Inverse. |
| Print Color | Color of the print region. |
| Size Text Region | Sizing for the print region. Shrink/ |
| | Enlarge Width and Height. |

The attributes for barcode print region 202 are defined in Table II as follows:

TABLE II

| Attribute | Description |
|---|---|
| Print Region Data (<pr_data>) | Permanently stored data. Can modify |
| | if <pr_att> = dynamic, increment, or |
| | decrement |
| Region ID (<r_id>) | Print Region identifier. Unique |
| | alphanumeric character. |
| Barcode Type (<obj_id>) | An object identifier which describes the |
| | type of barcode used. |
| Print Region Attributes | Special handling instructions for the |
| | print region. |
| (<pr_att>) | Options for barcodes include: Dynamic, |
| | Stored, Increment, or Decrement. |
| Barcode Width (<mul_1>) | The first width of the barcode. |
| Barcode Width2 (<mul_2>) | The second width of the barcode. |
| Rotation (<rot>) | Rotation of strings or data with print |
| | region. Options include: 0, 90, 180, |
| | or 270 Degrees. |
| Justification (<just>) | Justification of data within print region. |
| | Options include: Left, Right, or Center. |
| Barcode Height (<obj_att>) | The height of the barcode. |
| Print Color | Color of the print region. |
| Size Barcode Region | Sizing for the print region. Shrink/ |
| | Enlarge Width and Height. |

The attributes for line print region 203 are defined in Table III as follows:

TABLE III

| Attribute | Description |
|---|---|
| Region ID (<r_id>) | Print Region identifier. Unique Alphanumeric |
| | Character. |
| Line (<obj_id>) | An object identifier which describes a line. |
| Line Thickness | The thickness of the line. |
| (<mul_1>) | |
| Rotation (<rot>) | Rotation of strings or data with print region. Options |
| | include: 0, 90, 180, or 270 Degrees. |
| Size Line Region | Sizing for the print region. Shrink/Enlarge Width |
| | and Height |

The attributes for box print region 204 are defined in Table IV as follows:

TABLE IV

| Attribute | Description |
|---|---|
| Region ID (<r_id>) | Print Region identifier. Unique Alphanumeric |
| | Character. |
| Box (<obj_id>) | An object identifier which describes a box. |
| Line Thickness | The thickness of the line. |
| (<mul_1>) | |
| Size Box Region | Sizing for the print region. Shrink/Enlarge Width |
| | and Height |

The attributes for graphic print region 205 are defined in Table V as follows:

TABLE V

| Attribute | Description |
|---|---|
| Region ID (<r_id>) | Print Region identifier. Unique Alphanumeric |
| | Character. |
| Graphic (<obj_id>) | An object identifier which describes a graphic. |
| File Name | Name of the graphic file. |

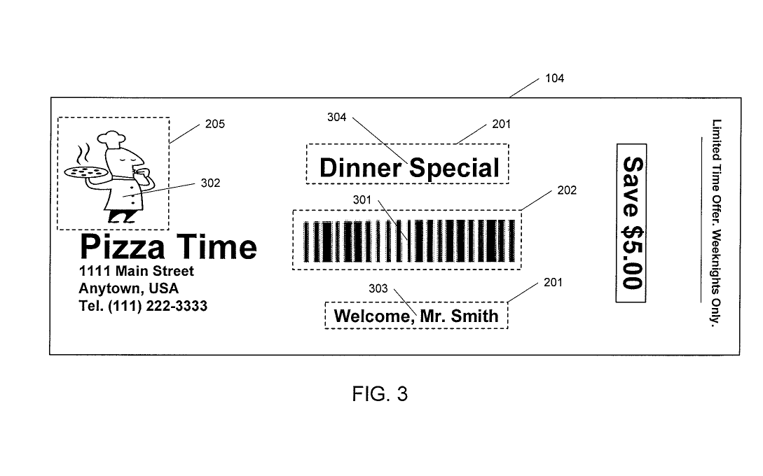

FIG. 3 is an illustration of an exemplary promotional coupon 104 including logical fields in accordance with an exemplary embodiment of the present invention. In this example, promotional coupon 104 may include five types of print regions: text, barcode, graphic, line, and box as described in FIG. 2. The print regions of a promotional coupon template used to create this example are defined in the promotional couponing system and may be stored in a printer, such as printer 108. The template may include a plurality of print regions in combination, resulting in a paste-up style printed promotional coupon.

The actual value of data for each print region may or may not be included in the promotional coupon template. For example, a promotional coupon template may include a barcode field 202 for printing a barcode 301. However the actual value of the barcode is transmitted to printer 108 at the time promotional coupon 104 is generated using promotional coupon template 103. In this way, promotional coupon 104 may have print regions that include static data, such as a graphic 302 in graphic print region 205, or dynamic data such as the name 303 of a particular patron in a text print region 201. In this way, customized promotional coupons may be printed by printer 108 without transferring large amounts of data through a communications network coupling printer 108 to a master promotional controller.

In addition, data that is used to track usage of promotional coupons may be included in promotional coupon 104. For example, a barcode field 202 or a text field 201 may be used to print a barcode value 301 or text string 304 uniquely identifying promotional coupon 104. In this way, printer 108 creates an image of a barcode or barcodes, characters or marks that may be read by a gaming or vending machine bill acceptor on the same or another gaming or vending machine, allowing automatic acceptance of promotional coupons.

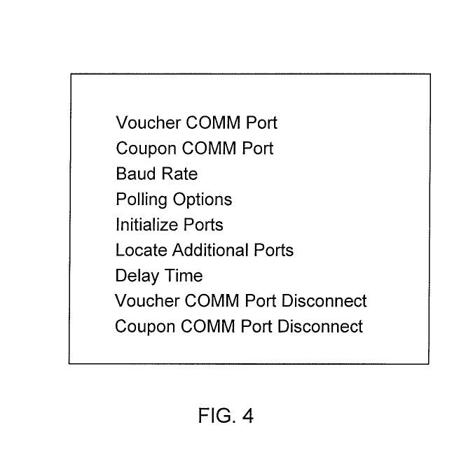

FIG. 4 is an illustration of the attributes of the communication settings with printer 108 in accordance with an exemplary embodiment of the present invention. The following describes each attribute. Voucher COMM Port is used to identify the communication port used for voucher printing. Promotional coupon COMM Port is used to identify the communication port used for promotional coupon printing. Baud Rate is used to set the data transmission rate for the Voucher COMM port and the Promotional coupon COMM port. Polling Options are used on the Voucher COMM Port and the Promotional coupon COMM port to poll the printer status. During polling, the status of the printer is sent to the promotional couponing system.

Initialize Ports is used to set up each port for data transmission. Locate Additional Ports is used to find other ports which may be available on a printer. Delay Time is used to set the time to delay printing of a voucher and a promotional coupon. Voucher COMM Port Disconnect is used to disconnect communication with the Voucher COMM Port. Promotional coupon COMM Port Disconnect is used to disconnect communication with the Promotional coupon COMM Port.

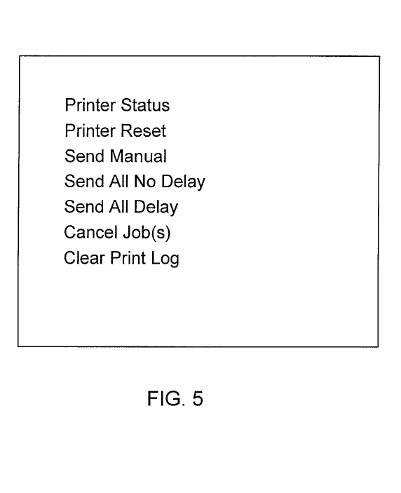

FIG. 5 is an illustration of the attributes of the printer settings in accordance with an exemplary embodiment of the present invention. The following describes each attribute. Printer Status is used to determine the status of the printer. Printer Reset is used to reset the printer should an error occur. Send Manual is used to manually send each print job to the printer. Send All No Delay is used to send all print jobs to the printer without delaying any of the print jobs. Send All Delay is used to send all print jobs to the printer using the Delay Time attribute of FIG. 4. Cancel Job(s) is used to cancel all print jobs currently queued to the printer. Clear Print Log is used to clear the file which logs each print job.

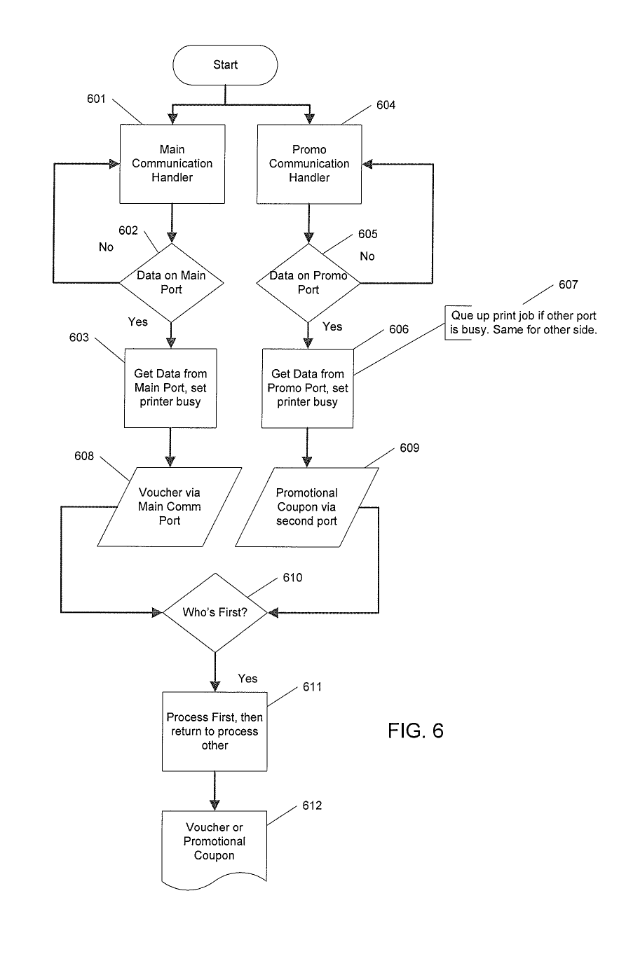

FIG. 6 is a process flow diagram for vouchers and promotional data in a gaming environment in accordance with an exemplary embodiment of the present invention.

As illustrated, the process for vouchers begins with a Main Communication Handler 601. A determination is made (602) whether data exists on the main port. If data, such as a voucher 608, exists on the main port, the system gets (603) the data from the main port and sets the printer to busy. If data does not exist on the main port, the process returns to Main Communication Handler 601.

The process for promotional coupons begins with a Promo Communication Handler 604. A determination is made (605) whether data exists on the promo port. If data, such as a promotional coupon 104, exists on the promo port, the system gets (606) the data 609 from the promo port and sets the printer to busy. If data does not exist on the promo port, the process returns to Promo Communication Handler 604.

If the printer is busy using any port, the data from the other port is queued (607).

The process continues with the system identifying (610) which data was received first. Because the process begins with Main Communication Handler 601 determining whether voucher data exists on the main port, if voucher data exists on the main port the voucher data will be identified at 610 as being received first. After identifying the data received first, the system processes (611) the first data to generate a voucher or promotional coupon, then returns to process the second data to generate (612) a voucher or promotional coupon.

In one embodiment, identifying which data was received first is based on a priority. For example, priority can be given to voucher data in the event that voucher data exists on the main port and promotional coupon data exists on the promo port. In another embodiment, priority can be given to voucher data such that even when promotional coupon data is received first, the system waits to receive and print corresponding voucher data prior to printing the promotional coupon data.

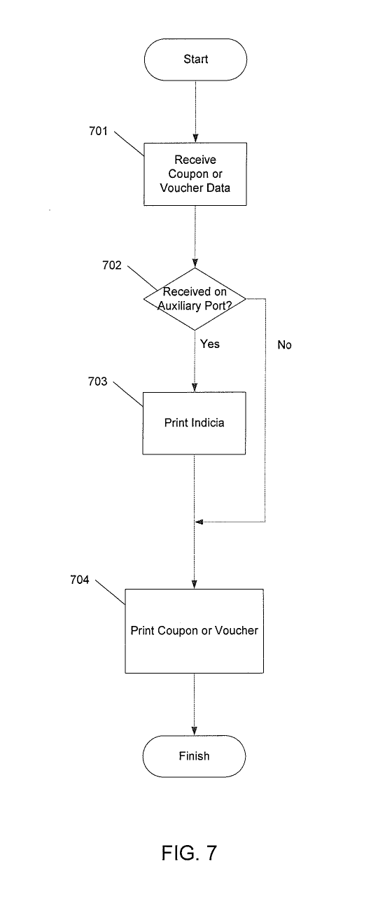

FIG. 7 is a process flow diagram for printing vouchers and promotional coupons in a gaming environment in accordance with an exemplary embodiment of the present invention.

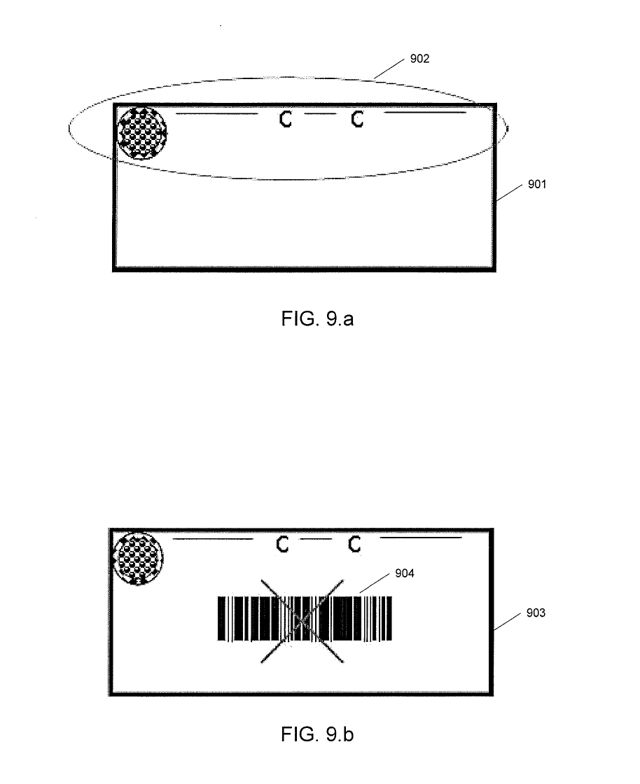

As illustrated, the process for printing vouchers or promotional data begins with a printer, such as printer 108, receiving (701) data, such as data for a promotional coupon 104 or a voucher 122. A determination is made (702) whether the data is received on an auxiliary port, such as a communication port configured for printing promotional coupons, among others. If the data is received on the auxiliary port, the printer prints (703) indicia, such as a background pattern, watermark, embossment or other indicia (as illustrated in FIG. 9a). The indicia may be in a human-readable format, such as visible text or patterns, or a tactile pattern created using a technique such as embossing. The indicia may also be in a machine-readable format such as a machine-readable pattern, text or barcode that may or may not be tangible to a human operator. The printer then prints (704) the data, thus indicating that the data was received on the auxiliary port. If the data is not received on the auxiliary port, such as a main port, the printer prints (704) the data without printing any such indicia.

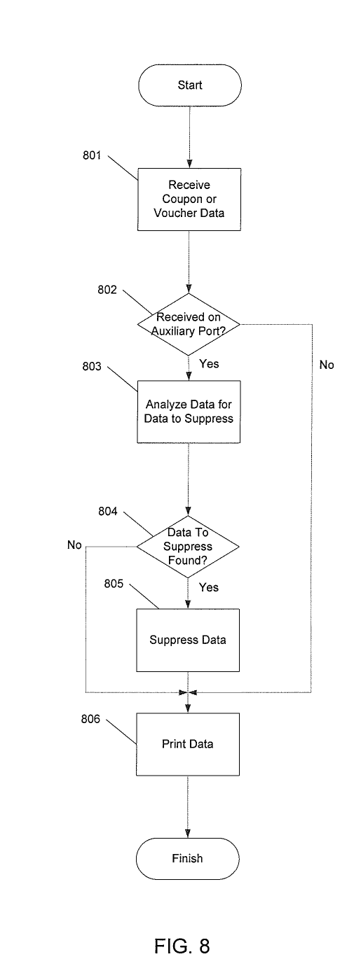

FIG. 8 is a process flow diagram for printing vouchers and promotional data in a gaming environment in accordance with an exemplary embodiment of the present invention.

As illustrated, the process for printing vouchers or promotional coupons begins with a printer, such as printer 108, receiving (801) data, such as data for a promotional coupon 104 or a voucher 122. A determination is made (802) whether the data is received on an auxiliary port, such as a communication port configured for printing promotional coupons, among others. If the data is not received on the auxiliary port, the printer prints (806) the data.

If the data is received on the auxiliary port, the printer analyzes (803) the data in order to find data to suppress, such as text, barcode, graphic, line, or box data as described in FIG. 3, among others, such data generating certain patterns which are not desirable to appear on the printed output because the data was received on an auxiliary port. A determination is made (804) whether the data received contains data to suppress. The determination of what data to suppress may be made using a variety of parameters. For example, barcodes, text and graphics appearing in particular orientations or locations may be suppressed. In addition, graphics and text may be analyzed to determine if they could be confused with a barcode. As another example, text having a particular arrangement, format or sequencing may be suppressed as well.

If data to suppress is not found, the printer prints (806) the data. If data to suppress is found, the printer suppresses (805) the data to suppress (as illustrated in FIG. 9b) and prints (806) the remaining data. This prevents certain data from being printed if it is received on the auxiliary port.

FIG. 9a is an illustration of printed output 901, such as promotional coupon 104 or voucher 122, after indicia 902 has been printed as described in FIG. 7.

FIG. 9b is an illustration of printed output 903, such as promotional coupon 104 or voucher 122, showing suppressed data 904 being suppressed as described in FIG. 8.

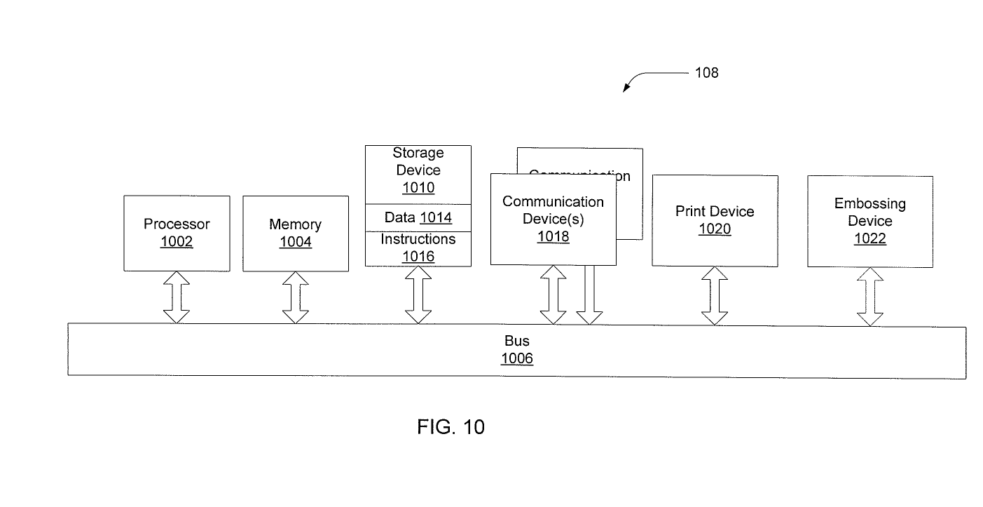

FIG. 10 is a block diagram of a printer in accordance with an exemplary embodiment of the present invention. A printer 108 includes a processor 1002, operatively coupled via a bus 1006 to a memory 1004. The processor is further operatively coupled via the bus to a storage device 1010. Program instructions 1016 and data 1014 implementing previously described voucher and promotional coupon printing processes are stored in the storage device until the processor retrieves the program instructions and stores them in the memory. The processor then executes the program instructions stored in the memory and uses the data to implement the features of the printer as previously described.

The processor is further coupled via the bus to one or more communication devices or ports 1018. The printer uses the communication devices to transmit and receive control signals from a promotion generation system, gaming system or gaming machine as previously described.

The processor is further coupled via the system bus to a print device 1020. The printer uses the print device to generate vouchers or promotional coupons as previously described.

Optionally, the processor may be further coupled to an embossing device 1022. The printer uses the embossing device to emboss vouchers or promotional coupons as previously described.

The foregoing description of the components of printer 108 is provided by way of example and not of limitation, it being understood that printer 108 could be implemented in a variety of ways without deviating from the spirit of the invention. For example, the processor 1002 could be constructed from hardware such as hardwired circuits within a controller. Alternatively, printer 108 could also be constructed from a combination of hardware and software components.

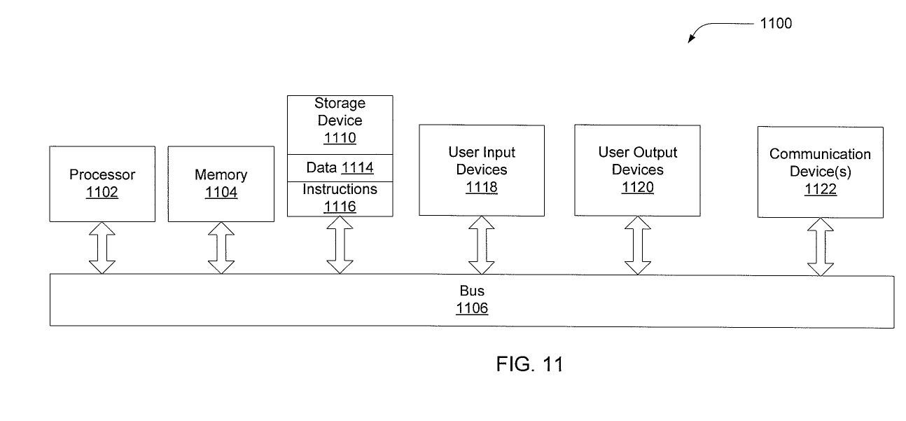

FIG. 11 is a block diagram of a host system for hosting a process for creation of a promotion in accordance with an exemplary embodiment of the present invention. A host 1100 includes a processor 1102, operatively coupled via a bus 1106 to a memory 1104. The processor is further operatively coupled via the bus to a storage device 1110. Program instructions 1116 and data 1114 for implementing the previously described promotional program generation processes are stored in the storage device until the processor retrieves the program instructions and stores them in the memory. The processor then executes the program instructions stored in the memory and uses the data to implement the features of the promotional program generation processes as previously described.

The processor is further coupled via the bus to one or more communications devices or ports 1122. The host uses the communications devices to transmit and receive control signals to and from external devices as previously described.

The processor is further coupled via the bus to one or more user input devices 1118 and one or more user output devices 1120 for communicating with a user as previously described in order to create a promotional program.

The foregoing description of the components of host 1100 is provided by way of example and not of limitation, it being understood that host 1100 could be implemented in a variety of ways without deviating from the spirit of the invention. For example, the processor 1102 could be constructed from hardware such as hardwired circuits within a controller. Alternatively, host 1100 could also be constructed from a combination of hardware and software components.

Although the present invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supportable by this application and the claims' equivalents rather than the foregoing description.

What is claimed is:

1. A method of operating a printer having a main port and an auxiliary port, comprising appending printed indicia to printed output upon receiving data on the auxiliary port, thereby identifying that the printed output was driven by data received on the auxiliary port.

2. The method of claim 1, wherein the auxiliary port includes a communication port configured for printing promotional coupons.

3. The method of claim 1, wherein the indicia is a background pattern.

4. The method of claim 1, wherein the indicia is a watermark.

5. The method of claim 1, wherein the indicia is an embossment.

6. The method of claim 1, wherein the indicia may be human readable.

7. The method of claim 1, wherein the indicia may be machine readable.

8. A method of operating a printer having a main port and an auxiliary port, comprising:
receiving data on the auxiliary port;
analyzing the received data to determine printable data in the received data which are not desirable to appear on the printed output driven by data on the auxiliary port; and
suppressing the determined data.

9. The method of claim 8, wherein the suppressed determined data includes text for a voucher.

10. The method of claim 8, wherein the suppressed determined data includes a barcode for a voucher.

11. The method of claim 8, wherein the suppressed determined data includes graphic data for a voucher.

12. The method of claim 8, wherein the suppressed determined data includes line data for a voucher.

13. The method of claim 8, wherein the suppressed determined data includes box data for a voucher.

14. The method of claim 8, wherein the suppressed determined data includes position data for a voucher.

15. A printer having a main port and an auxiliary port, comprising an appending unit configured to append printed indicia to printed output upon receiving data on the auxiliary port, thereby identifying that the printed output was driven by data received on the auxiliary port.

16. The printer of claim 15, wherein the auxiliary port includes a communication port configured for printing promotional coupons.

17. The printer of claim 15, wherein the indicia is a background pattern.

18. The printer of claim 15, wherein the indicia is a watermark.

19. The printer of claim 15, wherein the indicia is an embossment.

20. The printer of claim 15, wherein the indicia may be human readable.

21. The printer of claim 15, wherein the indicia may be machine readable.

22. A printer having a main port and an auxiliary port, comprising:
a receiving unit configured to receive data on the auxiliary port;
an analyzing unit configured to analyze the received data to determine printable data in the received data which are not desirable to appear on printed output generated using data received on the auxiliary port; and
a suppressing unit configured to suppress the determined data.

23. The printer of claim 22, wherein the suppressed determined data includes text for a voucher.

24. The printer of claim 22, wherein the suppressed determined data includes a barcode for a voucher.

25. The printer of claim 22, wherein the suppressed determined data includes graphic data for a voucher.

26. The printer of claim 22, wherein the suppressed determined data includes line data for a voucher.

27. The printer of claim 22, wherein the suppressed determined data includes box data for a voucher.

28. The printer of claim 22, wherein the suppressed determined data includes position data for a voucher.
